(19) United States
(12) Patent Application Publication
(10) Pub. No.: US 2014/0172294 A1
(43) Pub. Date: Jun. 19, 2014

(54) METHOD AND SYSTEM FOR PREDICTING EXPECTED TIME OF ARRIVAL OF OBJECTS

(71) Applicant: Magnasoft Consulting India Pvt. Ltd, Bangalore (IN)

(72) Inventors: Bobbie H. Kalra, Bangalore (IN); Shyam Ramamurthy, Bangalore (IN); Debojit Dutta, Bangalore (IN)

(73) Assignee: Magnasoft Consulting India Pvt. Ltd, Bangalore (IN)

(21) Appl. No.: 14/108,263

(22) Filed: Dec. 16, 2013

(30) Foreign Application Priority Data
Dec. 14, 2012 (IN) 5234/CHE/2012

(51) Int. Cl. G01C 21/34

(52) U.S. Cl. CPC G01C 21/3407
USPC 701/465

(57) ABSTRACT

The embodiment provides a method for predicting Expected Time of Arrival (ETA) of an object. The method includes tracking location data of the object and estimating time of arrival of the object based on the location data and historic data of one or more objects. Further, the method includes determining whether the object reached a predefined area based on the location data of the object and sending a notification about the ETA of the object to a remote entity upon determining that the object reached the predefined area.

The present application is based on, and claims priority from, Indian Application Number 5234/CHE/2012, filed on 14 Dec., 2012, the disclosure of which is hereby incorporated by reference herein.

### TECHNICAL FIELD

The present embodiment relates to data communications, and more particularly to prediction methods and systems for predicting and notifying Expected Time of Arrival (ETA) of moving objects.

### BACKGROUND

Generally, objects/vehicles such as bus, truck, train, plane, or any other vehicle travels along a usual route/sequence passing through a set of designated stops. It would be desirable for a user to know an expected time of arrival (ETA) of the vehicle to a desired stop/location. The user may be interested to know the vehicle is a particular distance (for example, number of miles, kilometers, or heights) away from the desired stop such that the user can plan and avoid arriving too early/late to the desired stop.

Many different methods and systems are proposed to track the vehicle location and notify the ETA of the vehicle to the user(s). In real-time, there are significant factors like traffic jams, road blocks, road construction, and the like, which can result in deviation from the usual route/sequence travelled by the vehicle. Existing methods and systems uses GPS (global positioning system) to track the vehicle location and estimate the ETA of the vehicle to a particular stop, and accordingly provide notifications to the users.

Although the existing methods and systems are effective in predicting the ETA of the vehicles, but includes both advantages and disadvantages in terms of vehicles with route deviations (or off-routes), accurate estimation of time of arrival of the vehicle, and providing effective notifications to the users. Thus, there remains a need of a robust method and system for predicting the accurate ETA of a vehicle to a stop, particular for vehicles with deviation in usual route.

### OBJECT

The principal object of the embodiments herein is to provide a method and system for predicting expected time of arrival (ETA) of an object to a stop.

Another object of the embodiment is to provide a mechanism for predicting ETA of an object with deviation in usual route (off-route).

Another object of the embodiment is to provide a method and system for providing effective notifications to remote user(s) about ETA of an object to a stop.

### SUMMARY

Accordingly the embodiment provides a method for predicting Expected Time of Arrival (ETA) of an object. The method includes tracking location data of the object and estimating time of arrival of the object based on the location data and historic data of one or more objects. Further, the method includes determining whether the object reached a predefined area based on the location data of the object and sending a notification about the ETA of the object to a remote entity upon determining that the object reached the predefined area.

Furthermore, the method includes determining whether the object reached a stop in the predefined area and estimating time of arrival of the object based on the location data and the historic data of the one or more objects. Furthermore, the method includes sending a notification about the ETA of the object to the remote entity upon determining that the object is yet to reach the stop in the predefined area.

In an embodiment, the historic data of the one or more objects described herein includes average time taken by the one or more objects to reach each stop of a route, average time taken by the one or more objects to reach the predefined area of each stop of the route, and average time taken by the one or more objects to reach each stop from the predefined area of the route.

Furthermore, the method includes creating route information of the one or more objects. The creation of the route information further includes tracking time taken by the one or more objects to reach each stop in the route and averaging the time by creating a Geographic centroid. Furthermore, creation of the route information includes plotting the average time of the one or more objects on a Geographic information system of the route and creating the predefined area around each stop based on the average time of the one or more objects.

Furthermore, the method includes storing the route information of the one or more objects, the historic data of the one or more objects, the ETA, and the location data of the object. Furthermore, the method includes periodically tracking the location data of the object and adjusting the ETA based on the location data of the object.

In an embodiment, the method further includes determining whether the object reached a primary stop, or a secondary, or a predefined area of the primary stop, or a predefined area of the secondary stop. Furthermore, the method includes estimating time of arrival of the object based on the location data and the historic data of the one or more objects and sending a notification about the ETA of the object to a remote entity upon determining that the object reached the primary stop, or the secondary stop, or the predefined area of the primary stop, or the predefined area of the secondary stop.

Furthermore, the method includes optimizing the historic data based on the location data of the object.

Furthermore, the method includes providing a graphical user interface to receive the location information of the object.

Accordingly the embodiment provides a system for predicting Expected Time of Arrival (ETA) of an object. The system includes a sensor module configured to track location data of the object and a controller module configured to estimate the ETA of the object based on the location data and historic data of one or more objects. Further, the controller module is configured to determine whether the object reached a predefined area based on the location data of the object. Further, the system includes a communications module configured to send a notification about the ETA of the object to a remote entity upon determining that the object reached the predefined area.

In an embodiment, the controller module is further configured to determine whether the object reached a stop in the predefined area and estimate ETA of the object based on the location data and the historic data of the one or more objects. Furthermore, the communications module is configured to send a notification about the ETA of the object to the remote entity upon determining that the object is yet to reach the stop in the predefined area.

In an embodiment, the controller module is further configured to create route information of the one or more objects. The creation of the route information further includes track the time taken by the one or more objects to reach each stop in the route and average the time by creating a Geographic centroid. Further, the creation of the route information includes plot the average time of the one or more objects on a Geographic information system of the route and create the predefined area around each stop based on the average time of the one or more objects.

Furthermore, the system includes a storage module configured to store the route information, the historic data of the one or more objects, the ETA, and the location data of the object.

Further, the sensor module is configured to periodically track the location data of the object and the controller module is configured to adjust the ETA based on the location data of the object.

In an embodiment, the controller module is further configured to determine whether the object reached a primary stop, or a secondary, or a predefined area of the primary stop, or a predefined area of the secondary stop. Further, the controller module is configured to estimate ETA of the object based on the location data and the historic data of the one or more objects. Furthermore, the communications module is configured to send a notification about the ETA of the object to a remote entity upon determining that the object reached the primary stop, the secondary stop, or the predefined area of the primary stop, or the predefined area of or the secondary stop.

Furthermore, the system includes an optimization module configured to optimize the historic data based on the location data of the object.

Furthermore, the system includes a user interface module configured to provide a graphical user interface to receive the location data of the object.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 illustrates generally, among other things, an exemplary environment in which various embodiments of present embodiment operates;

FIG. 2 illustrates generally, among other things, exemplary components of system as described in the FIG. 1, according to embodiments as disclosed herein;

FIG. 3 depicts a flowchart illustrating operations performed by the system, as described in the FIG. 2, for creating route information of one or more vehicles, according to embodiments as disclosed herein;

FIG. 4 depicts is a schematic diagram showing an example of a predefined area created around each stop of route as described in the FIG. 3, according to embodiments as disclosed herein;

FIG. 5 depicts a flowchart illustrating operations performed for predicting ETA of a vehicle based on historic data of the one or more vehicles, according to embodiments as disclosed herein;

FIG. 6 depicts a flowchart illustrating operations performed for predicting ETA of a vehicle with deviation in usual route, according to embodiments as disclosed herein; and

FIG. 7 depicts a computing environment implementing the application, in accordance with various embodiments of the present embodiment.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for predicting Expected Time of Arrival (ETA) of an object. The system is configured to capture route data of one or more objects using Global Positioning System (GPS) devices of the objects. A storage including historic data of the one or objects is populated based on the GPS data received from the one or more objects. An average time taken for the one or more objects to reach each stop of a route is calculated by creating a Geographic centroid and is plotted on Geographic information system (GIS) of the route. A predefined area is determined around each stop based on the average times, which defines on an average, the time taken by an object to reach a particular stop in the route.

Further, the method and system includes tracking real-time location data of a moving object. The ETA of the object is determined based on the tracked location data and historic data of the one or more objects. The historic data described herein includes average time taken by the one or more objects to reach each stop of the route, average time taken by the one or more objects to reach the predefined area of each stop of the route, and average time taken by the one or more objects to reach each stop from the predefined area of the route. Furthermore, a notification about the ETA of the object is sent to a remote entity upon determining that the object reached a predefined area of a route.

The method and system disclosed herein is simple, robust, and reliable to provide accurately estimate the ETA of an object/vehicle. The method and system can be used to predict the ETA of any type of vehicle, particular for the vehicles with deviation in usual routes. Further, effective notifications are provided to remote passengers/user(s) about the ETA of the vehicle. The notifications send by the system are effective because it is sent only when the bus reaches a specific stop/predefined area of the stop.

The proposed method and system is advantageous in predicting ETA of vehicles travelling on usual routes or with deviation in usual routes (route-off). The method and system can be used in multiple areas such as school/college transport services, cargo/logistics management, railways, airways, and the like. Further, for a given fixed route or for a given amount of information, the present embodiment can be used in tracking arrival/delivery times of goods, articles, or any other object and also to determine timelines/deadlines for any business transactions.

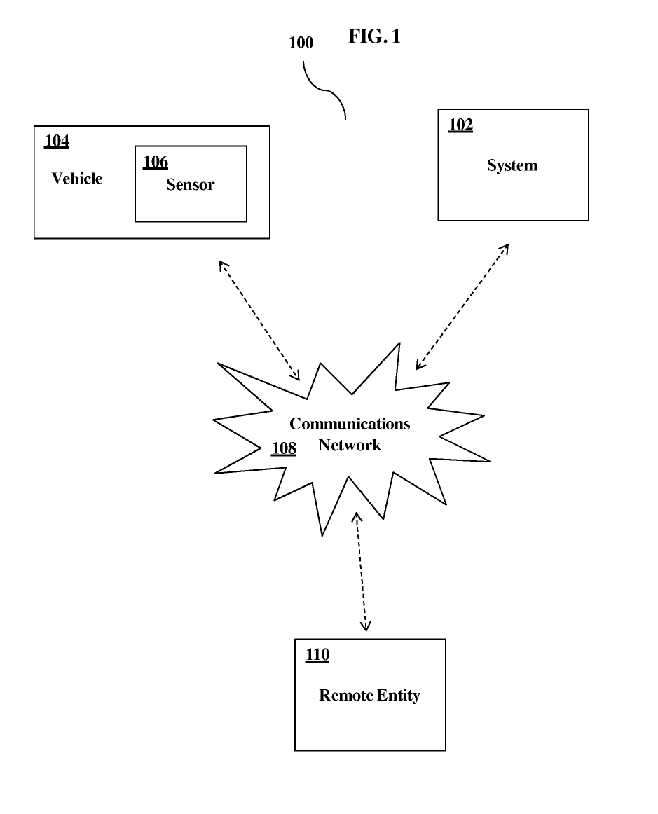

Referring now to the drawings, and more particularly to FIGS. 1 through 7, where similar reference characters denote corresponding features consistently throughout the figures, there are shown preferred embodiments.

Throughout the description, the term object and vehicle is used interchangeably.

Throughout the description, the term remote entity, remote user, and passenger are used interchangeably.

FIG. 1 illustrates generally, among other things, an exemplary environment 100 in which various embodiments of present embodiment operate. The environment 100 includes a system 102 for tracking and predicting Expected Time of Arrival (ETA) of an object/vehicle 104. In an example, the vehicle 104 described herein can be a bus, truck, train, plane, bike, or any other vehicle/object. In an embodiment, the vehicle 104 may be located at a particular location on a geographic area of the Earth surface or may be flying in the air, and a sensor 106 can be configured to determine the vehicle location. In an embodiment, the sensor 106 described herein can be a global positioning system (GPS) sensor, monitoring stations, or any other sensor capable of tracking location of a moving vehicle. The sensor 106 can be configured to be associated/coupled to the vehicle 104. Further, the sensor 106 can be configured to track the location data of the vehicle 104 using the techniques known in the art and send to the system 102 for further processing through a communications network 108. In an embodiment, the communications network 108 described herein can include, wireless communications network, communications network, cellular communications network, the Internet, General packet radio service (GPRS) network, Global System for Mobile Communication (GSM) network, satellite communications, combination thereof, or any other communications network.

In an example, the sensor 104 can be configured to receive one or more GPS signals from the system 102 to track the current location of the vehicle 104. The sensor 104 can receive the one or more GPS signals and calculate the location data (e.g., latitude/longitude coordinates, so on) of the vehicle 104. The sensor 104 can be configured to transmit the calculated coordinate values indicating the location data of the vehicle 104 to the system 102 for further processing. The system 102 is configured to process the location data to predict expected time of arrival (ETA) of the vehicle 104 to one or more stops, in accordance to embodiments described further herein.

Further, the system 102 can be configured to send notification about the ETA of the vehicle 104 to a remote entity 110. In an example, the term “remote entity” described herein can be, for example, a mobile phone, communications device, wireless electronic device, or any other device of passenger, parent, or user waiting for the vehicle 104. In an embodiment, the notification described herein can include, the ETA of the vehicle 104, current location of the vehicle 104, distance (in miles, heights, and kilometers) from the current location of the vehicle 104 to the designated stop of the remote entity 110, or any other information associated with the vehicle 104. The system 102 is configured to include required information about the remote entity 110 to send the notification about the ETA.

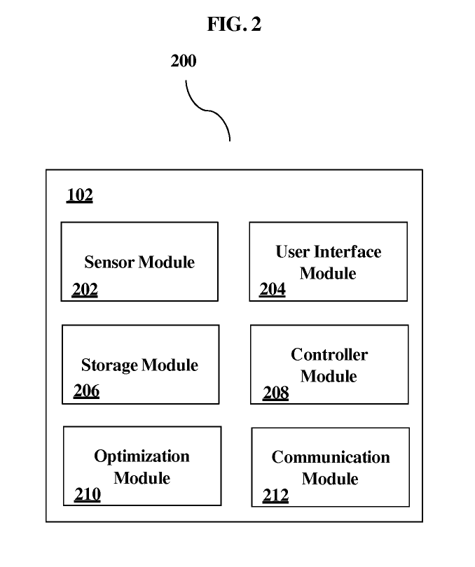

FIG. 2 illustrates generally, among other things, exemplary components 200 of the system 102 as described in the FIG. 1, according to embodiments as disclosed herein. The system 102 can be configured to include a sensor module 202, a user interface module 204, a storage module 206, a controller module 208, an optimization module 210 and a communications module 212.

In an embodiment, the sensor module 202 is configured to send one or more GPS signal to the sensor 106 such as to track current location of the vehicle 104. The sensor module 202 described herein may include one or more antennas that allow the sensor module 202 to wirelessly transmit/receive signal/location data to/from the sensor 106. Further, the system 102 is configured to store the received location information in the storage module 206.

In an embodiment, the user interface module 204 can be configured to provide a graphical user interface to driver (or any other user) of the vehicle 104. In an example, if due to any real-time event such as traffic, jam, construction, change in usual route, or the like, the vehicle 104 is blocked or stuck then the driver can use the graphical user interface to provide the location information of the vehicle 104. In an embodiment, the driver can provide the current event information such as “stuck in jam or traffic” along with manual estimated amount of time (decided by the driver based on the real-time event) required to reach a specific stop of the route. Such an event driven model can allow the system 102 to accurately estimate the ETA of the vehicle 104 and provide effective notifications to the remote entity 110.

In an embodiment, the storage module 206 can be configured to store route information of the one or more vehicles and the received location data of the vehicle 104. In an embodiment, storage module 206 can be configured to store historic data including average time taken by the one or more vehicles to reach each stop of the route, average time taken by the one or more vehicles to reach predefined area of each stop of the route, average time taken by the one or more vehicles to reach each stop from the predefined area of the route, or any other information associated with the one or more vehicles. Further, the storage module 206 can be configured to store the data in the form of a tuple including a combination of rows and columns, stacks, queues, lists, or in any other form. In an embodiment, the storage module 206 can be configured store the data in binary format or any other format, which can be processed by the system 102. The storage module 206 described herein can be any type of local/remote database/data warehouse capable of storing and interfacing with local and remote components of the system 102.

In an embodiment, the location data of the vehicle 104 is tracked regularly (or periodically) and stored in the system 102. The controller module 208 can be configured to analyze the location data of the vehicle 104 and identify each stop in a route that the vehicle 104 travels. The controller module 208 can be configured to determine time taken by the vehicle 104 to reach each stop of the route based on the location data of the vehicle 104. In an example, the controller module 208 can determine that a stop-A may be X minutes away from a stop-B, stop-C, and so on. Similarly, a stop B may be X minutes away from the stop-C, Stop-D, and so on.

Further, for each stop, the controller module 208 can be configured to calculate an average of the determined time taken by the vehicle 104 to reach the stops of the route by creating a Geographic centroid. In an embodiment, the controller module 208 can use historic location data of over 15 days, a month, or any other time period to calculate the average time required for the vehicle 104 to reach each stop of the route.

In an example, the controller module 208 can be configured to plot the Geographic centroid (the average value) for each stop on a Geographic information system (GIS) of the route. The controller module 208 can be configured to create a predefined area (also referred as route segment) around each stop of the route. The term “predefined area” or the “route segment” described herein may determine a Geo-fence around each stop of the route, which on an average, determines the time taken by the vehicle 104 to reach a stop in the route. In an embodiment, the controller module 208 can be configured to create a buffer of about Y meters around the predefined area of each stop such as to avoid delays or deviations for the vehicle 104 while reaching the predefined area of each stop. In an example, the buffer can be used to avoid delays, if the vehicle 104 does not reaches a predefined area of a stop after the average time to reach the predefined area of that stop is elapsed.

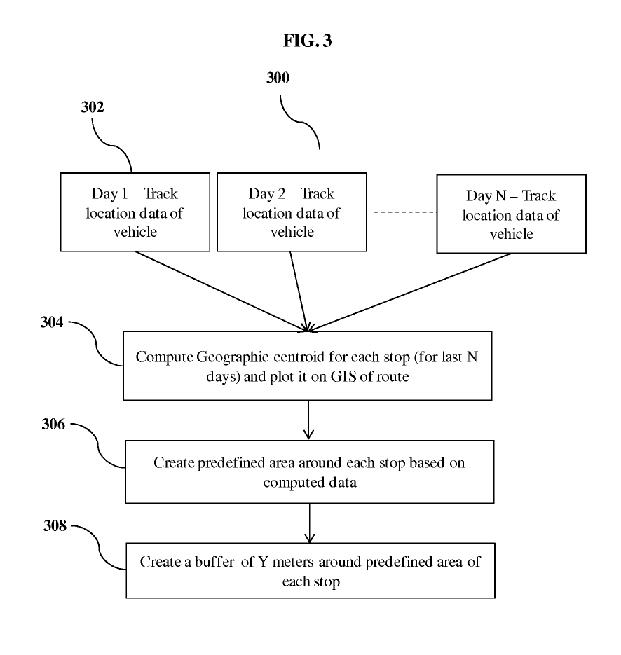

In an embodiment, the system 102, in communication with the storage module 206, can be configured to store and use these determined historic data (including the average time taken by the one or more vehicles to reach each stop of the route, the average time taken by the one or more vehicles to reach predefined area of each stop of the route, the average time taken by the one or more vehicles to reach each stop from the predefined area of the route, and any other information) to predict the ETA of one or more vehicles. Further, operations performed by the system 102 to predict the ETA of a vehicle is described in conjunction with FIGS. 3, 5, and 6.

In an embodiment, the optimization module 210 can be configured to regularly optimize the historic data based on the received location data of the vehicles. The optimization module 210 can be configured to regularly backup and update the historic data based on real time location data of the one or more vehicles. A variety of techniques, rules, criteria, formulae, and functions can be implemented to optimize the historic data such as to provide accurate ETA of the one or more vehicles. In an example, the optimization module 210 optimizes the historic data by continuously monitoring and updating the historic data (including the average time taken by the one or more vehicles to reach each stop of the route, the average time taken by the one or more vehicles to reach predefined area of each stop of the route, the average time taken by the one or more vehicles to reach each stop from the predefined area of the route, and any other information) based on the ETA of one or more vehicles and actual (real-time) time taken by the one or more vehicles to reach a predefined area/a stop of the route. This optimal data can then be used to improve efficiency of the system 102 by accurately predicting ETA's of the one or more vehicles, which may further improves quality of service.

In an embodiment, the system 102 can be configured to send notification about the ETA of the one or more vehicles to the remote entity 110. The system 102 can be configured to use the communications module 212 to communicate and send notifications to the remote entity 110. In an embodiment, the system 102 can notify the remote entity 110 about the ETA of the one or more vehicles via a Short Message Service (SMS), voice/video call, text chat, Email, Multimedia Messaging Service (MMS), and so on. The communications module 212 can be configured to include interface with channels of various devices (both local and remote) to provide the notification about the ETA to one or more remote entities. Alternatively, the system 102 can be configured to allow the remote entity to directly enquire/communicate with the system 102 about the ETA of the one or more vehicles.

FIG. 3 depicts a flowchart illustrating operations 300 performed by the system 102, as described in the FIG. 2, for creating route information of the one or more vehicles, according to embodiments as disclosed herein. In an embodiment, at 302, the system 102 can be configured to track location data of the one or more vehicles over a predefined time period. In an example, the sensor module 202 can send one or more GPS signals to the vehicle sensor 106 to regularly track location data of the one or more vehicles. In an example, the location data of a predefined period (such as 1-N days, a month, or any other time period) can be stored in the system 102.

In an embodiment, at 304, the system 102 can be configured to compute a Geographic centroid for each stop of the route (for last N days) and plot it on the GIS of the route. In an example, the controller module 208 can be configured to determine time taken by the one or more vehicles to reach each stop of the route based on the tracked location data of the one or more vehicles over the predefined time period. For each stop, the controller module 208 can calculate an average of the determined time taken by the one or more vehicles to reach each stop by creating the Geographic centroid. Further, the Geographic centroid (average value of time) can be plotted on the GIS model of the route. Furthermore, the average time taken to reach each stop of the one or more vehicles is stored in the storage module 206.

In an embodiment, at 306, the system 102 is configured to create a predefined area (or route segment) around each stop based on the computed data. In an example, the controller module 208 can determined a predefined area, which indicates on an average the time taken by the one or more vehicles to reach a stop in the route. In an example, same/different predefined areas can be created around each stop based on the determined time taken by the one or more vehicles to reach each stop in the route.

In an embodiment, at 308, the controller module 208 can be configured to create a buffer of Y meters around the predefined area of each stop in the route. In an example, the buffer of Y meters is created to avoid delays or deviations for a vehicle while reaching the predefined area of each stop.

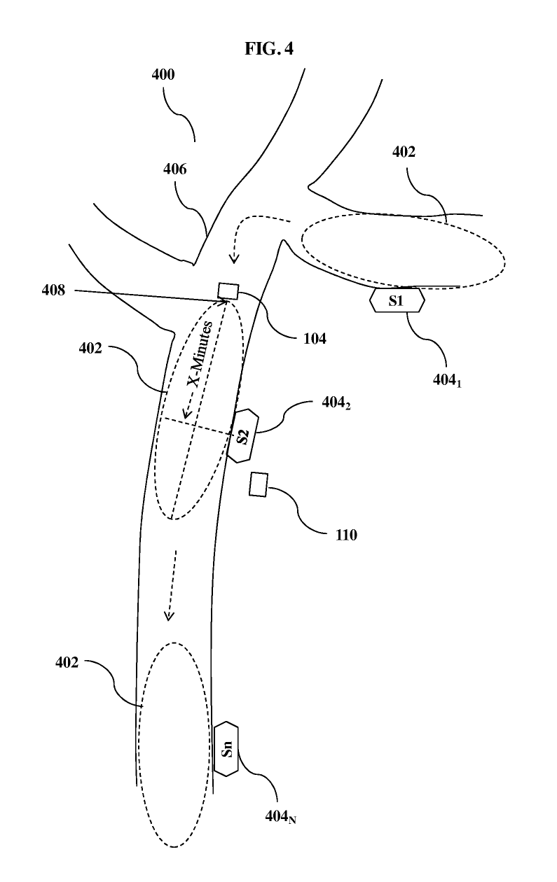

FIG. 4 depicts is a schematic diagram 400 showing an example of a predefined area 402 created around each stop 404₁₋ₙ (here after referred as 404) as described in the FIG. 3, according to embodiments as disclosed herein. In an embodiment, a predefined area 402 is created around each stop 404 of a route 406. The average time take by one or more vehicles to reach a predefined area 402 of each stop 404 of the route 406 and the average time take by one or more vehicles to reach a stop 404 from the predefined area 402 of the route 406 can be calculated and stored in the system 102. In an example, as shown in the FIG. 4, if the vehicle 104 travels along the route 406 passing though the stops 404, in the indicated direction, the predefined area 402 for the stop 404₂ is computed so that when the vehicle 104 reaches within a point 408 of the predefined area 402, the system 102 predicts the ETA of the vehicle 104 to the stop 404₂ based on the historic data (including average time taken by the one or more vehicles to reach the stop 404₂ from the predefined area 402). For example, if the system 102 determines that average time taken by the one or more vehicles to reach the stop 404₂ is X-minutes, based on the historic data, then the system 102 sends a notification to the remote entity 110 about the ETA of the vehicle 104 to the stop 404₂.

In an example, the system 102 can send a notification including the ETA of the meeting as X minutes or the system 102 can add a buffer time of Y minutes to the expected time such as to provide effective notification to the remote entity 110

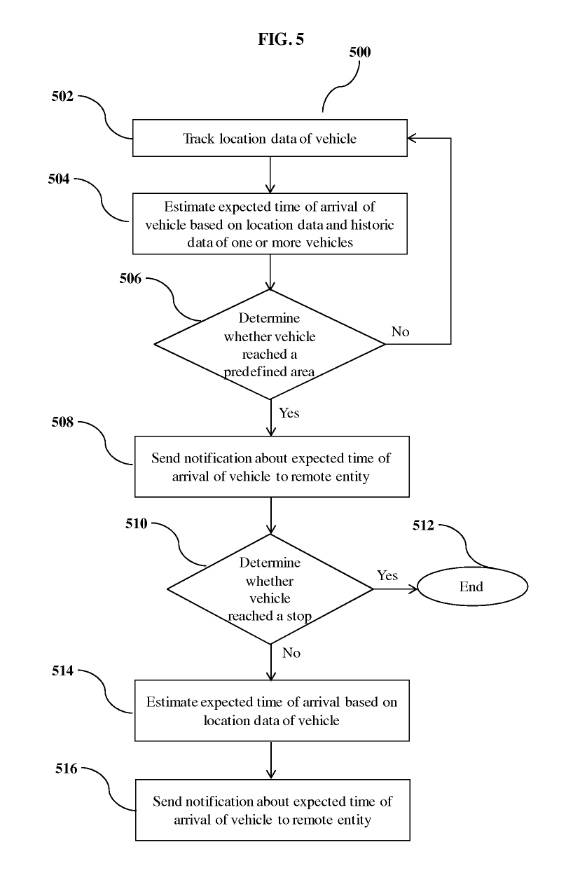

FIG. 5 depicts a flowchart illustrating a method or operations 500 performed for predicting the ETA of the vehicle 104 based on the historic data of the one or more vehicles, according to embodiments as disclosed herein. In an embodiment, at 502, method 500 includes tracking location data of the vehicle 104. In an example, the sensor module 202 can send one or more GPS single to the vehicle sensor 106 to track current location of the vehicle 104. The sensor 106 can determine the location coordinates of the vehicle 104 and provide the location data to the sensor module 202.

In an example, if due to any real-time event such as traffic, jam, construction, change in usual route, or the like, the vehicle 104 is blocked or stuck then the driver can use the user interface module 204 to provide the location information of the vehicle 104. In an embodiment, the driver can provide the current event information such as “Stuck in jam due to an accident” along with manual estimated amount of time (decided by the driver based on the real-time event) required to reach a specific stop of the route.

In an embodiment, at 504, the method 500 includes estimating time of arrival of the vehicle 104 based on the location data and the historic data of the one or more vehicles. In an example, the controller module 208 can analyze the location data of the vehicle 104 and estimates the ETA of the vehicle 104 based on the historic data of the one or more vehicles. In an example, the historic data can include the average time taken by the one or more vehicles to reach each stop of the route, the average time taken by the one or more vehicles to reach predefined area of each stop of the route, the average time taken by the one or more vehicles to reach each stop from the predefined area of the route, and any other information.

In an embodiment, at 506, the method 500 includes determining whether the vehicle 104 reached a predefined area. In an example, the controller module 208 can use the received location data to determine whether the vehicle 104 reached the predefined area of any stop in the route.

In an embodiment, at 508, the method 500 includes sending a notification about the ETA of the vehicle 104 to the remote entity 110. In an example, upon determining that the vehicle 104 reached the predefined area of the stop, the controller module 208 (in communication with the communications module 212) sends the notification including the determined ETA of the vehicle 104. In an example, the notification described herein can include the ETA of the vehicle (e.g., the vehicle can arrive within 15 minutes) or the ETA of the vehicle with some buffer time (e.g., the vehicle can arrive between 7:00 and 7:20 AM).

In an embodiment, the method 500 includes repeating the steps 502-506, upon determining that the vehicle 104 is yet to reach the predefined area of the stop. In an example, if the received location data of the vehicle 104 determines that the vehicle 104 had not reached the predefined area of the stop, then the system 102 waits for a standard time and again sends a request to receive the current location data of the vehicle 104 and estimate the ETA of the vehicle 104 by repeating the steps 502-506.

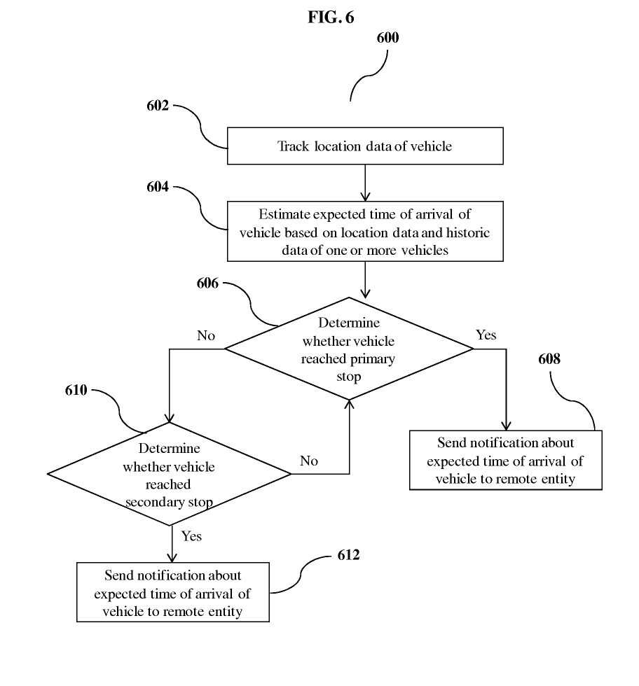

In an embodiment, the controller module 208 periodically monitors the location data of the vehicle 104 so as to determine whether the vehicle 104 reached a stop or reached a predefined area of the stop. For example, if the vehicle 104 includes a deviation in its usual, then the periodic monitoring of the location data of the vehicle 104 allows the system 102 to estimate the ETA of the vehicle 104 based on its current location data and historic data of the one or more vehicles. Upon determining that the vehicle 104 reached a stop or reached a predefined area of the stop, the controller module 208 provides notification to the remote entity 110 about the ETA. The operations performed by the system 102 in case of route deviation are explained in more detailed in conjunction with FIG. 6.

In an embodiment, at 510, the method 500 includes determining whether the vehicle 104 reached the stop. After the vehicle 104 entered the predefined region the notification about the ETA of the vehicle 104 is sent to the remote entity 110. But, in real-time, due to traffic jam, road blockage, or any other reason the vehicle 104 may get delayed or may not reach the stop within the expected time. To handle such scenarios, the controller module 208 can periodically monitor the location or uses the input information received from the driver of the vehicle 104 to determine whether the vehicle 104 reached the stop within the expected amount of time.

In an embodiment, at 512, upon determining that the vehicle 104 reached the stop within the expected amount of time the method 500 ends. In an embodiment, at 514, upon determining that the vehicle 104 has not reached the stop within the expected amount of time, the method 500 includes estimating the time of arrival based on the location data of the vehicle 104. In an example, the controller module 208 can determine the current location of the vehicle 104 and re-estimate the ETA of the vehicle 104. Alternatively, the controller module 208 can query the driver to provide the estimated amount of time (decided by the driver based on the real-time event) required to reach the stop.

Further, at 516, the method 500 includes sending another notification about new ETA of the vehicle 104 to the remote entity 110. In an example, the controller module 208 can send another notification including the new ETA of the vehicle 104 to the remote entity 110. The another notification send to the remote entity 110 may include the current location of the vehicle 104, distance of the vehicle 104 from the stop, the ETA, and any other information associated with the vehicle 104.

FIG. 6 depicts a flowchart illustrating method or operations 600 performed for predicting ETA of a vehicle with deviation in usual route, according to embodiments as disclosed herein. In real-time, due to road construction, traffic jam, blockage, or any other reason, the vehicles may deviates from its usual route or may skip (or may not reach) one or more stops in the usual sequence of stops present in the usual route. In such scenarios, the system 102 can be configured to include primary and secondary stops to accurate track whether a stop is skipped by the vehicle in the usual sequence of stops and provide effective notifications to the remote entities such as described below.

In an embodiment, at 602, the method 600 includes monitoring location of the vehicle 104. In an example, the sensor module 202 can send one or more GPS single to the vehicle sensor 106 to track current location of the vehicle 104. The sensor 106 can determine the location coordinates of the vehicle 104 and provide the location data to the sensor module 202. In an example, the driver of the vehicle 104 can use the graphical user interface (provided by the user interface module 204) provide the location information of the vehicle 104. In an example, the driver can also provide the current event information (if occurred) such as “Changed the usual route due to jam” along with manual estimated amount of time (decided by the driver based on the real-time event) required to reach a specific stop of the route.

In an embodiment, at 604, the method 600 includes estimating time of arrival of the vehicle 104 based on location data and historic data of the one or more vehicles. In an example, the controller module 208 can analyze the location data of the vehicle 104 and estimates the ETA of the vehicle 104 based on the historic data of the one or more vehicles. In an example, the historic data can include the average time taken by the one or more vehicles to reach each stop of the route, the average time taken by the one or more vehicles to reach predefined area of each stop of the route, the average time taken by the one or more vehicles to reach each stop from the predefined area of the route, and any other information.

In an embodiment, at 606, the method 606 includes determining whether the vehicle 104 reached a primary stop. In an example, for the vehicles 104 in deviation in routes, the controller module 208 can categorize the stops such as the primary and secondary stops based on the current location data of the vehicle 104. The controller module 208 uses the received location data to determine whether the vehicle 104 reached the primary stop or reached the predefined area of the primary stop.

In an embodiment, at 608, the method 600 includes sending a notification about the ETA of the vehicle 104 to the remote entity 110. In an example, upon determining that the vehicle 104 reached the primary stop or a predefined area of the primary stop, the controller module 208 (in communication with the communications module 212) sends the notification including the determined ETA of the vehicle 104. In an example, the notification described herein can include the ETA of the vehicle, current location of the vehicle, or any other information associated with the vehicle.

In an embodiment, at 610, upon determining that the vehicle 104 has not reached the primary stop or a predefined area of the primary stop, the method 600 includes determine whether the vehicle 400 reached the secondary stop or a predefined area of the secondary stop. In an example, the controller module 208 uses the location data of the vehicle 104 to determine whether the vehicle 104 reached the secondary stop or the predefined area of the secondary stop.

In an embodiment, at 612, the method 600 includes sending a notification about the ETA of the vehicle 104 to the remote entity 110. In an example, upon determining that the vehicle 104 reached the secondary stop or the predefined area of the secondary stop, the controller module 208 can determine/adjust the ETA of the vehicle 104. Further, the controller module 208 can send a notification including the ETA of the vehicle 104 to the remote entity 110.

In an embodiment, upon determining that the vehicle 104 has not reached the secondary stop or predefined area of the secondary stop, the method 600 includes repeating the steps 606-610. In an embodiment, the system can periodically determine/adjust the ETA of vehicles based on vehicle location data, for both the vehicle with usual route or for the vehicles with deviation in the usual route. Further, the ETA can be adjusted with a buffer time so as to provide effective notifications to the remote entity in advance or to avoid slight delays in the reaching the stops within the ETA.

The various steps, blocks, or acts described with respect to the FIGS. 3, 5, and 6 can be performed in sequential order, in random order, simultaneously, parallel, or a combination thereof. Further, in some embodiments, some of the steps can be omitted, skipped, or added without departing from the scope of the embodiment.

Though the present embodiment is described with respect to a vehicle tracking system, but a person skilled in art can identify that the present embodiment can be used in tracking any type of object/items in cargo, logistics, courier, or the like services. Further, for a given fixed route or for a given amount of information, the present embodiment can be used in tracking arrival/delivery times of goods, articles, or any other object and also to determine timelines/deadlines for any business transactions.

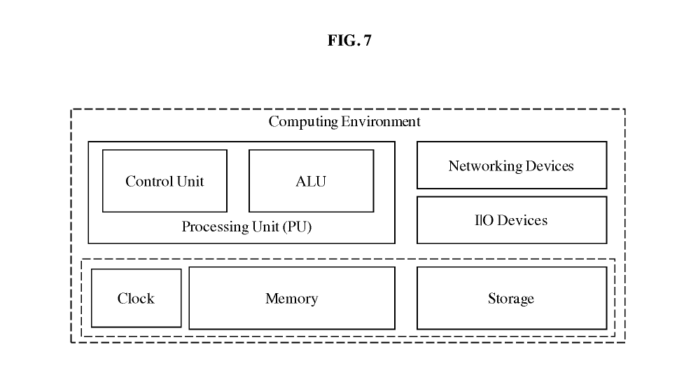

FIG. 7 depicts a computing environment implementing the application, in accordance with various embodiments of the present embodiment. As depicted, the computing environment comprises at least one processing unit that is equipped with a control unit and an Arithmetic Logic Unit (ALU), a memory, a storage unit, a clock chip, plurality of networking devices, and a plurality Input output (I/O) devices. The processing unit is responsible for processing the instructions of the algorithm. The processing unit receives commands from the control unit in order to perform its processing. Further, any logical and arithmetic operations involved in the execution of the instructions are computed with the help of the ALU.

The overall computing environment can be composed of multiple homogeneous and/or heterogeneous cores, multiple CPUs of different kinds, special media and other accelerators. The processing unit is responsible for processing the instructions of the algorithm. The processing unit receives commands from the control unit in order to perform its processing. Further, any logical and arithmetic operations involved in the execution of the instructions are computed with the help of the ALU. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit. The processing unit synchronizes the operations and executes the instructions based on the timing signals generated by the clock chip. The embodiments disclosed herein can be implemented through at least one software program running on at least one hardware device and performing network management functions to control the elements. The elements shown in the FIGS. 1-7 include various units, blocks, modules, or steps described in relation with methods, processes, algorithms, or systems of the present embodiment, which can be implemented using any general purpose processor and any combination of programming language, application, and embedded processor.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for predicting Expected Time of Arrival (ETA) of an object, the method comprising:
tracking location data of said object;
estimating ETA of said object based on said location data and historic data of at least one object;
determining whether said object reached a predefined area based on said location data of said object; and
sending a notification about said ETA of said object to a remote entity upon determining that said object reached said predefined area.

2. The method of claim 1, wherein said method further comprises:
determining whether said object reached a stop in said predefined area;
estimating ETA of said object based on said location data and said historic data of said at least one object; and
sending a notification about said ETA of said object to said remote entity upon determining that said object is yet to reach said stop in said predefined area.

3. The method of claim 1, wherein said historic data of said at least one object comprises at least one of average time taken by said at least one object to reach each stop of a route, average time taken by said at least one object to reach said predefined area of each stop of said route, and average time taken by said at least one object to reach each stop from said predefined area of said route.

4. The method of claim 1, wherein said method further comprises providing a user interface to receive said location data of said object.

5. The method of claim 1, wherein said method further comprises creating route information of said at least one object.

6. The method of claim 5, wherein creation of said route information further comprises:
tracking time taken by said at least one object to reach each stop in said route;
averaging said time taken by said at least one object to reach each stop by creating a Geographic centroid;
plotting said average time of said at least one object on a Geographic information system of said route; and
creating said predefined area around each stop based on said average time of said at least one object.

7. The method of claim 1, wherein said method further comprises storing said route information of said at least one object, said historic data of said at least one object, said ETA, and said location data of said object.

8. The method of claim 1, wherein said method further comprises periodically tracking said location data of said object.

9. The method of claim 1, wherein said method further comprises adjusting said ETA based on said location data of said object.

10. The method of claim 1, wherein said method further comprises:
determining whether said object reached at least one of a primary stop, a secondary, a predefined area of said primary stop, and a predefined area of said secondary stop;
estimating ETA of said object based on said location data and said historic data of said at least one object; and
sending a notification about said ETA of said object to a remote entity upon determining that said object reached at least one of said primary stop, said secondary stop, said predefined area of said primary stop, and said predefined area of said secondary stop.

11. The method of claim 1, wherein said method further comprises optimizing said historic data based on said location data of said object.

12. A system for predicting Expected Time of Arrival (ETA) of an object, the system comprising:
a sensor module configured to track location data of said object;
a controller module configured to:
estimate ETA of said object based on said location data and historic data of at least one object, and
determine whether said object reached a predefined area based on said location data of said object; and
a communications module configured to send a notification about said ETA of said object to a remote entity upon determining that said object reached said predefined area.

13. The system of claim 12,
wherein said controller module is further configured to
determine whether said object reached a stop in said predefined area, and estimate ETA of said object based on said location data and said historic data of said at least one object; and
wherein said communications module is further configured to send a notification about said ETA of said object to said remote entity upon determining that said object is yet to reach said stop in said predefined area.

14. The system of claim 12, wherein said historic data of said at least one object comprises at least one of average time taken by said at least one object to reach each stop of a route, average time taken by said at least one object to reach said predefined area of each stop of said route, and average time taken by said at least one object to reach each stop from said predefined area of said route.

15. The system of claim 12, wherein said system further comprises a user interface module configured to provide a graphical user interface to receive said location data of said object.

16. The system of claim 12, wherein said controller module is further configured to create route information of said at least one object.

17. The system of claim 16, wherein creation of said route information further comprises:
track time taken by said at least one object to reach each stop in said route,
average said time taken by said at least one object to reach each stop by creating a Geographic centroid,
plot said average time of said at least one object on a Geographic information system of said route, and
create said predefined area around each stop based on said average time of said at least one object.

18. The system of claim 12, wherein said system further comprises a storage module configured to store said route information, said historic data of said at least one object, said ETA, and said location data of said object.

19. The system of claim 12, wherein said sensor module is further configured to periodically track said location data of said object.

20. The system of claim 12, wherein said controller module is further configured to adjust said ETA based on said location data of said object.

21. The system of claim 12,
wherein said controller module is further configured to
determine whether said object reached at least one of a primary stop, a secondary, a predefined area of said primary stop, and a predefined area of said secondary stop, and
estimate ETA of said object based on said location data and said historic data of said at least one object; and
wherein said communications module is further configured to send a notification about said ETA of said object to a remote entity upon determining that said object reached at least one of said primary stop, said secondary stop, said predefined area of said primary stop, and said predefined area of said secondary stop.

22. The system of claim 12, wherein said system further comprises an optimization module configured to optimize said historic data based on said location data of said object.
